(19) United States
(12) Patent Application Publication
(10) Pub. No.: US 2014/0282655 A1
(43) Pub. Date: Sep. 18, 2014

(54) System and method for targeted mobile ad delivery based on consumer TV programming viewing habits

(71) Applicant: Jason Shay Roberts, Millbrae, CA (US)

(72) Inventor: Jason Shay Roberts, Millbrae, CA (US)

(21) Appl. No.: 13/844,480

(22) Filed: Mar. 15, 2013

(51) Int. Cl. H04N 21/466; G06Q 30/02; H04N 21/81

(52) U.S. Cl. CPC H04N 21/4667; H04N 21/812; G06Q 30/0255
USPC 725/14

(57) ABSTRACT

The present disclosure relates to systems and methods for gathering analytical information on TV viewers to provide targeted ads on mobile devices. SDKs are provided that allows for the capture of viewers' TV watching habits through their personal electronic devices. The TV watching habits are analyzed and stored to create user profiles. Based on these user profiles, highly relevant and targeted ads are matched and delivered to individual users.

### TECHNICAL FIELD

The present disclosure relates generally to systems and methods that provide for delivery of targeted mobile ad delivery based on TV viewing habits of individual consumers.

### BACKGROUND

Even though consumer electronics and the face of entertainment have changed significantly over the last 10 years, consumers are still watching a lot of television. According to Nielsen, at least 83% of people in over 50 countries watch TV regularly and spend an average of 34 hours per week in front of TV. What has changed is how consumers are watching TV. Again according to Nielsen, 85% of tablet and smartphone owners use their device as a second screen while watching TV at least once a month with 40% of them doing it daily.

In this new environment, advertisers are losing eyes during commercial breaks as people turn to their mobile device or hit the 30 second skip on the remote control. They are seeking innovative and effective ways to reach consumers.

Identifying the TV program and the associated demographic significantly increases the mobile ad revenue. This benefits everyone in the mobile advertising chain with the publisher getting more income for their inventory, the ad network getting more revenue without increasing share percentage, the advertiser reaching their target audience more efficiently, and the consumer by providing a better user experience by way of receiving ads that are relevant.

### BRIEF SUMMARY

The solution reaches consumers on their mobile device while they are watching television and targets ads based on the programs being watched. The solution does the following:
Provides ubiquitous SDKs that allow app and mobile website developers and owners to easily monetize mobile ad inventory at high value
Captures a fingerprint of the program being watched in background and identifies program without disrupting user experience
Identifies demographic and target user group based on current program being viewed as well as viewing history of individual users
Combines learning with complex data algorithms including user profiling and sentiment analysis
Ascertains advertiser demand in real-time
Delivers targeted advertising messages to the mobile devices utilizing Real-Time Bidding and other modern mobile ad matching and delivery mechanisms.

The solution provides an effective way for advertisers to reach their target audience while they are engaged with the mobile device. It also facilitates an environment where consumers are receiving mobile ads that are relevant to them. For example, someone watching a football game might get an ad for $10 off an order for a pizza. A mobile user who has children's programming in the background might get an ad for the toy sale. Someone that watches daytime programming and fashion related TV might get an ad for the latest women's shoes. FIG. 2 provides a high level view of how mobile ads are delivered based on whether or not the solution is employed.

The solution is not application specific. It can be implemented in nearly any mobile app or website and works on any smart device that has a microphone. It works while the user is watching live or recorded programming and it runs in the background, thus not disrupting the user experience.

The solution provides the end to end solution including:
The SDK Installed in the app or mobile website
Integration into the comprehensive mobile ad network ecosystem
The data analysis and sentiment engine

By anonymously storing the viewing history of a user, the solution allows for the delivery of targeted advertising even when the user is not watching television programming at the time a mobile ad is delivered. The solution continually builds on and analyzes the programs a user watches to deliver the best ad at the right time. The solution can even be combined with geo location applications to provide even greater targeting and value. For example, if the user has been identified as someone that watches golf instruction shows on TV, a mobile ad may be displayed for a local golf store in the area of the user.

Data and sentiment analysis is at the core of the solution. The metadata from the television programs is continually analyzed along with viewers' habits to provide the best targeting possible. The program title, genre, description, cast, theme, etc. is used to determine which ad is the most appropriate for an individual user. For example, if someone watches programs in which a specific actress stars as well as a talk show in which she appears, they may get presented an ad to pre-purchase tickets to a new actress's movie.

User habits are also analyzed to not only deliver the best ad but also do it at the right time. This is done based on data such as what type of ads in which a user is likely to engage or if someone is more likely to click on an ad early or late in a program or during a commercial break. Additional information is incorporated as well such as the ideal number of times and period a user is shown an ad to achieve engagement.

Sentiment analysis around the main topics of the program being watched is a key component to the solution. Using the sentiment engine a determination is made whether the sentiment concerning the topic is positive or negative. If the sentiment is positive then an ad related to that specific topic is more likely to be delivered. Conversely, if the sentiment is negative toward a certain topic then an ad related to that topic is more likely to be avoided.

The solution also provides valuable feedback to advertisers with comprehensive reporting and results from the sentiment analysis engine. For example, the solution continually monitors key websites including blogs and social networks to determine the current and trending sentiment towards an advertiser, product, or specific campaign. Advertisers can use this information to tailor their campaigns and ad spending to their best interests and those of their consumers.

### BRIEF DESCRIPTION OF THE DRAWINGS

FIG. 1 is a block diagram illustrating the system at a high level.

FIG. 2 is a flow chart illustrating the standard flow through the system.

### DETAILED DESCRIPTION

For a more complete understanding of the present disclosure and its advantages, reference is now made to the following description taken in conjunction with the accompanying drawings, in which like reference numbers indicate like features.

### FIG. 1

FIG. 1 is a high level diagram of the system as a whole, the main components and how they interact with each other.

One way to implement the described embodiments is to provide an SDK (piece or pieces of code) to an app developer to be incorporated into an existing app. Thus, an app running the presently described approach can insert the SDK and run on a ‘smart’ mobile device and will work on any smart device that has a microphone. The app that contains the SDK could be something directly related to TV related material or be completely unrelated (e.g., a game such as Angry Birds). While the app is being used for its intended activity, in the background a small sound fingerprint is recorded and sent as described below via an Application Programming Interface (“API”) for identification against a database of recorded TV Broadcasts (movies and music as well). If the fingerprint is identified then the broadcast related data is analyzed along with existing user data to create a profile for a targeted mobile ad to be delivered to the mobile device. The program data is also stored with the existing user data to enhance the user profile.

Devices 110 represent consumer mobile devices including but not limited to mobile phones, tablets, laptops, and personal smart devices.

App Server 104 is a server that is related directly to the specific app or website in use on the mobile device. The App Server 104 in this context represents functions directly related to the app such downloading the app for the first time, accessing additional features and functions, registration, and it can also act as a gatekeeper for activities such as ad delivery. The App Server 104 may or may not be involved in the mobile ad delivery process but is represented in FIG. 1 as it will sometimes be the first point of access.

Main Application Server 102 is at the core of the solution. It manages the main processes including data analysis, user profiling, database storage management, interaction with devices 110, Ad Server 130, and Merchant Server 120. The Main Application Server 102 communicates with the devices 110 to receive an audio fingerprint and gather anonymous user identifiers and specific viewing data. The user and viewing data is stored in the User Database 108. The Main Application Server 102 also does a Sentiment Analysis on the main topics of the program during the time of user viewing. This sentiment is used to help determine if an ad related to the main topic should be sent or avoided. The Main Application Server 102 analyzes the newly acquired data along with the existing user and program data to build a profile for an ad request. The ad request with the profile is subsequently sent to the Ad Server 130, sometimes via the Merchant Server 120. Once the ad is received from the Merchant Server 120, it logs the ad details in the User Database 108 and delivers the ad to the devices 110. The Main Application Server 102 receives subsequent User Ad Activity data based on the user's behavior with the ad and stores it in the User Database 108. The User Ad Activity includes data such as if the user clicked on the ad, when they clicked on the ad, and what they did after clicking on the ad.

Media Database 150 is the database that stores the TV program information which includes sound matching files as well as program metadata. The Media Database 150 receives the sound fingerprint from the Main Application Server 102 and looks for a match against the sound files in the database. If a match is found it returns the program name and additional program information including the original broadcast channel, the time at which the broadcast originally took place, and other descriptive details including genre, program description, main topics at time of broadcast and specific spoken words around the topics. The fingerprint matching files and technology as well as program related data could be generated in-house, licensed and accessed from a third party, or any combination thereof.

User Database 108 stores user information including identifiers and profiles. The user information is stored under an anonymous ID associated with the specific device or application. The user data includes raw data as well as analyzed data from TV programming viewing habits, apps used, interaction with served ads, device type, and other relevant data. The users do not have access to their user data.

Program Memory 103 provides all the logic and programs used for data analysis, sentiment analysis, user profile building, ad-to-profile matching, etc. The logic and programs are stored as computer-readable instructions that can be accessed by the Main Application Server 102 to execute the functions described in the disclosed embodiments.

Merchant Server 120 is the entity behind the app or mobile website utilizing the solution. This may or may not interact directly with the Main Application Server 102. The Merchant Server 120 is owned and maintained by an outside party and in most cases manages many components of the app or mobile website such as game scores, multi-player sessions, etc. Oftentimes, the Merchant Server 120 also manages ad selection and delivery and in this case the Main Application Server 102 would communicate directly with the Merchant Server 120. In other cases where the ad component is not handled by the Merchant Server 120, there may be no requirement for direct communication from the Main Application Server 102.

Ad Server 130 is where the ads that are ultimately delivered to the devices are located. This could include mobile ad network, mobile advertising platform, a real-time bidding system, or other ad delivery mechanism. When the Main Application Server 102 generates a profile for an ad it sends it to the Ad Server 130 for a match to that profile. The request could include a request based on a specific demographic such as a male, age 21-30, interested in sports. The Ad Server 130 would then find a match, ideally at the highest paying advertiser for that demographic, and then send the ad back to the Main Application Server 102 for ultimate delivery to the devices 110. Additional examples of profiles could include a golf ad for zip code xxxxx or movie tickets for the upcoming release of the movie starring a specific actress.

Media Server 140 encompasses the TV programming that is delivered to users. The variety of delivery mechanisms is vast and may include traditional broadcast television to a standard television set, a streaming solution such as Netflix to a laptop, a DVD being watched on a game console, as well as a number of other solutions. The creation and source of the broadcast content is independent of the solution. When a user is using an app with the SDK component of the solution embedded it can recognize the program being broadcast regardless of the delivery source of that broadcast.

### FIG. 2

FIG. 2 shows the standard flow through the system.

Step 201: The app or mobile website developer incorporates the SDK code into their source code before distribution to the users. The SDK includes all the code that facilitates the capturing of the sound fingerprint as well as all the communication between the devices 110 and the Main Application Server 102. The SDK can be made available to the developers in a number of different ways. It could be downloaded from a website or provided directly by a mobile ad network, a mobile carrier or other third party.

Step 202: The user downloads the app that contains the SDK and installs on their device 110. The app can be downloaded from any location authorized to provide mobile apps to users. The app could also have been pre-installed on the device 110. The user then launches the app and uses it for its intended purpose. The app may or may not be related to television.

Step 203: At a pre-established interval, a fingerprint is taken of the background sound while the user is within the app. The fingerprint is captured without any disruption of the user experience.

Step 204: The sound fingerprint is sent to the Main Application Server 102 for identification against the Media Database 150.

Step 205: The Media Database 150 determines if the fingerprint matches any program within the database as described earlier in the document.

Step 206: If there is a match from Step 205, the data available for the TV program is analyzed by the Main Application Server 102.

Step 207: Once the data from the TV program is analyzed it is combined with the analyzed User Profile Data from the User Database 108 and a profile for the ad(s) to be requested is created by the Main Application Server 102.

Step 208: If there is not a match from Step 205, the existing User Profile Data from the User Database 108 is analyzed by the Main Application Server 102 and a profile for the ad(s) to be requested is created for submission to the Ad Server 130.

Step 209: A request for a mobile ad based on the created profile is submitted by the Main Application Server 102 to the Ad Server 130 and an ad is returned from the Ad Server 130 with relevant details. Details could include elements like dimension of the ad, structure of the ad (e.g. static, rich media, video), how many components of the profile were a match, cost and required action (e.g. view, click, sign up).

Step 210: The ad is delivered to the device 110 so it can be displayed at the time stipulated by the app. Some examples of the proper time to display an app would include during a commercial break in the TV program or in between levels of a game. The ad could be audio, video, or web banner.

Step 211: The data from the user interaction with the ad is captured and sent to the Main Application Server 102 for analysis and subsequent storage in the User Database 108.

What is claimed is:

1. A method for gathering TV viewer analytical information based on capture of viewer TV watching habits through a personal electronic device, the method comprising:
a) providing computer readable instructions for execution by a computer processor when such computer readable instructions are installed on a user's personal electronic device, the code when executed operable to gather TV viewer watching information through a built-in microphone on the personal electronic device;
b) receiving captured audio fingerprints captured by the personal electronic device in an application server in communication with the personal electronic device, the capturing and sending occurring substantially in the background of the user's use of the application whereby the activity occurs substantially without disrupting the user's other interaction with their personal electronic device;

2. The method of claim 1 wherein the computer readable instructions are provided to a developer for integration into another application for operation on a personal electronic device.

3. The method of claim 2 wherein when the another application is being used for its intended activity, in the background a sound fingerprint is recorded and sent via API for identification against a database of recorded broadcasts or other media.

4. The method of claim 3 wherein the recorded broadcasts are selected from the group consisting of TV programming, movies, and music.

5. The method of claim 1 wherein the received audio fingerprints are compared against a database of recorded broadcasts or other media.

6. The method of claim 5, the method further comprising performing analytics on the captured audio fingerprints using the comparison against the database of recorded broadcasts or other media to consider the various program data such as genre, key topics, and time of day being watched.

7. The method of claim 6 wherein a viewer demographic profile is established based on analysis of program data.

8. The method of claim 6 wherein sentiment analysis surrounding the main topics is done through a comprehensive sentiment analysis engine portion of the main server or in another server.

9. The method of claim 6, wherein program analysis and sentiment data are then analyzed relative to an existing user profile.

10. The method of claim 9 wherein a targeted ad is identified and delivered back to the user based on the analysis.

11. The method of claim 9 wherein the analysis is further used to determine the profile of the most relevant and valuable ad to request.

12. The method of claim 11 wherein a request is made to a series of mobile ad networks and real-time bidding systems.

13. The method of claim 12 wherein the most valuable ad is identified it is delivered to the user.

14. The method of claim 9 wherein the user profile is updated using an anonymous ID to store all activates related to the user's behavior regarding program being watched and response to mobile ads.

15. The method of claim 14 wherein the user-related data is continually analyzed and updated to build a profile designed for targeted ads.

16. The method of claim 15 wherein the profile can be used to deliver ads even when the user is not watching TV programming during the time an ad is requested or delivered.
